(19) United States
(12) Patent Application Publication
(10) Pub. No.: US 2010/0251322 A1
(43) Pub. Date: Sep. 30, 2010

(54) UPSTREAM BANDWIDTH CONDITIONING DEVICE

(76) Inventors: Raymond Palinkas, Canastota, NY (US); Erdogan Alkan, Fayetteville, NY (US)

Correspondence Address: Marjama Muldoon/PPC, 250 South Clinton Street, Suite 300, Syracuse, NY, 13202, US

(21) Appl. No.: 12/534,955

(22) Filed: Aug. 4, 2009

Related U.S. Application Data
(60) Provisional application No. 61/164,800, filed on Mar. 30, 2009.
(60) Provisional application No. 61/186,604, filed on Jun. 12, 2009.

(51) Int. Cl. H04N 7/173

(52) U.S. Cl. 725/127

(57) ABSTRACT

An upstream bandwidth conditioning device that can be inserted into a signal transmission line of a CATV system on a premise of a user includes a main signal path and a filter array including a plurality of discrete signal filters coupled to the main signal path. Each of the signal filters is configured to reduce a signal level of at least one frequency portion of an upstream bandwidth. The device further includes a controller configured to select between a plurality of states. In at least two of the states at least one of the signal filters is selected such that a signal level of a lower frequency portion of the upstream bandwidth and a signal level of an higher frequency portion of the upstream bandwidth are reduced by a greater amount than a signal level of an intermediate frequency portion, which includes frequencies arranged between the lower frequency portion and the higher frequency portion.

### CROSS REFERENCE TO RELATED APPLICATIONS

This application claims priority under 35 U.S.C. §119(e) to U.S. Provisional Patent Application No. 61/164,800 entitled “UPSTREAM BANDWIDTH CONDITIONING DEVICE” filed Mar. 30, 2009, and U.S. Provisional Patent Application No. 61/186,604 entitled “UPSTREAM BANDWIDTH CONDITIONING DEVICE” filed on Jun. 12, 2009 which are incorporated herein by reference.

### FIELD OF THE INVENTION

The present invention relates generally to signal conditioning devices for use in cable television (“CATV”) systems, and in particular to signal conditioning devices that increase the signal-to-noise ratio of an upstream bandwidth in a CATV system.

### BACKGROUND OF THE INVENTION

The use of a CATV system to provide internet, voice over internet protocol (VOIP) telephone, television, security, and music services is well known in the art. In providing these services, a downstream bandwidth (i.e., radio frequency (“RF”) signals, digital signals, and/or optical signals) is passed from a supplier of the services to a user, and an upstream bandwidth (i.e., RF signals, digital signals, and/or optical signals) is passed from the user to the supplier. For much of the distance between the supplier and the user, the downstream bandwidth and the upstream bandwidth make up a total bandwidth that is passed via a signal transmission line, such as a coaxial cable. The downstream bandwidth is, for example, signals that are relatively higher frequencies within the total bandwidth of the CATV system while the upstream bandwidth is, for example, signals that are relatively lower frequencies.

Traditionally, the CATV system includes a head end facility, where the downstream bandwidth is initiated into a main CATV distribution system, which typically includes a plurality of trunk lines, each serving at least one local distribution network. In turn, the downstream bandwidth is passed to a relatively small number (e.g., approximately 100 to 500) of users associated with a particular local distribution network. Devices, such as high-pass filters, are positioned at various points within the CATV system to ensure the orderly flow of downstream bandwidth from the head end facility, through the trunk lines, through the local distribution networks, and ultimately to the users.

In stark contrast to the orderly flow of the downstream bandwidth, the upstream bandwidth passing through each of the local distribution networks is a compilation of an upstream bandwidth generated within a premise of each user that is connected to the particular distribution network. The upstream bandwidth generated within each premise includes desirable upstream information signals from a modem, desirable upstream information signals from a set-top-box, and undesirable interference signals, such as noise or other spurious signals. Many generators of such undesirable interference signals are electrical devices that inadvertently generate electrical signals as a result of their operation. These devices include vacuum cleaners, electric motors, household transformers, welders, and many other household electrical devices. Many other generators of such undesirable interference signals include devices that intentionally create RF signals as part of their operation. These devices include wireless home telephones, cellular telephones, wireless internet devices, CB radios, personal communication devices, etc. While the RF signals generated by these latter devices are desirable for their intended purposes, these signals will conflict with the desirable upstream information signals if they are allowed to enter the CATV system.

Undesirable interference signals, whether they are inadvertently generated electrical signals or intentionally created RF signals, may be allowed to enter the CATV system, typically through an unterminated port, an improperly functioning device, a damaged coaxial cable, and/or a damaged splitter. As mentioned above, the downstream/upstream bandwidth is passed through coaxial cables for most of the distance between the user and the head end. This coaxial cable is intentionally shielded from undesirable interference signals by a conductive layer positioned radially outward from a center conductor and positioned coaxial with the center conductor. Similarly, devices connected to the coaxial cable typically provided shielding from undesirable interference signals. However, when there is no coaxial cable or no device connected to a port the center conductor is exposed to any undesirable interference signals and will function like a small antenna to gather those undesirable interference signals. Similarly, a coaxial cable or device having damaged or malfunctioning shielding may also gather undesirable interference signals.

In light of the forgoing, it should be clear that there is an inherent, system-wide flaw that leaves the upstream bandwidth open and easily impacted by any single user. For example, while the downstream bandwidth is constantly monitored and serviced by skilled network engineers, the upstream bandwidth is maintained by the user without the skill or knowledge required to reduce the creation and passage of interference signals into the upstream bandwidth. This issue is further compounded by the number of users connected together within a particular distribution network, especially knowing that one user can easily impact all of the other users.

Attempts at improving an overall signal quality of the upstream bandwidth have not been successful using traditional methods. A measure of the overall signal quality includes such components as signal strength and signal-to-noise ratio (i.e., a ratio of the desirable information signals to undesirable interference signals). Traditionally, increasing the strength of the downstream bandwidth has been accomplished by drop amplifiers employed in or near a particular user's premise. The success of these drop amplifiers is largely due to the fact that there are very low levels of undesirable interference signals present in the downstream bandwidth for the reasons explained more fully above. The inherent presence of the undesirable interference signals in the upstream bandwidth generated by each user has typically precluded the use of these typical, drop amplifiers to amplify the upstream bandwidth, because the undesirable interference signals are amplified by the same amount as the desirable information signals. Accordingly, the signal-to-noise ratio remains nearly constant, or worse, such that the overall signal quality of the upstream bandwidth is not increased when such a typical, drop amplifier is implemented.

For at least the forgoing reasons, a need is apparent for a device, which can increase the overall quality of the upstream bandwidth that includes increasing the signal strength and increasing the signal-to-noise ratio.

### SUMMARY OF THE INVENTION

The present invention helps to reduce the effect of undesirable interference signals that are unknowingly injected into the main signal distribution system, through the upstream bandwidth, by the user. By selectively attenuating frequency ranges within the upstream bandwidth, the present invention increases the signal-to-noise ratio of the upstream bandwidth. The present invention further increases the signal strength by amplifying desirable information signals to further increase the overall signal quality.

In accordance with one embodiment of the present invention, an upstream bandwidth conditioning device is provided that can be inserted into a signal transmission line of a CATV system on a premise of a user. The device includes a main signal path, and a filter array including a plurality of discrete signal filters coupled to the main signal path. Each of the signal filters is configured to reduce a signal level of at least one frequency portion of an upstream bandwidth. The device further includes a controller configured to select between a plurality of states. In at least two of the states, at least one of the signal filters is selected such that a signal level of a lower frequency portion of the upstream bandwidth and a signal level of an higher frequency portion of the upstream bandwidth are reduced by a greater amount than a signal level of an intermediate frequency portion, which includes frequencies arranged between the lower frequency portion and the higher frequency portion. The intermediate frequency portion is larger in one of the states than in another of the states.

In accordance with one embodiment of the present invention, the plurality of signal filters includes an array of low-pass filters and an array of high-pass filters. Preferably, the controller selects at least one low-pass filter from the array of low-pass filters and at least one high-pass filter from the array of high-pass filters. In accordance with one embodiment of the present invention, the array of low-pass filters and the array of high-pass filters are coupled in series with the main signal path via switching means. Preferably, the low-pass filters in the array attenuate to a different maximum frequency and each of the high-pass filters in the array attenuate to a different minimum frequency. Preferably, the switching means includes at least two switches associated with each of the array of low-pass filters and the array of high-pass filters. Preferably, the switching means is an integrated circuit switch. In accordance with one embodiment of the present invention, the device further includes a signal amplification unit coupled to the main signal path.

In accordance with one embodiment of the present invention, the plurality of signal filters includes a plurality of band pass filters, each band pass filters being arranged between a ground and the main signal path and being selectively coupled to the main signal path by a respective switching means. Preferably, a selection of each band pass filter by closing the respective switching means results in an attenuation of a frequency range associated with the particular band pass filter. Preferably, the controller is configured to select each band pass filter by the respective switching means. Preferably, each of the plurality of band pass filters attenuates to a different maximum frequency and to a different minimum frequency. Preferably, the switching means is an integrated circuit switch. In accordance with one embodiment of the present invention, the device further includes a signal amplification unit coupled to the main signal path.

In accordance with one embodiment of the present invention, the plurality of signal filters comprises a plurality of band stop filters arranged in series with the main signal path and a bypass path including a respective switching means associated with each of the band stop filters. Preferably, the selection of a particular band stop filter by opening the respective switching means results in an attenuation of a frequency range associated with the particular band stop filter. Preferably, the controller is configured to select each band stop filter by the respective switching means. Preferably, the switching means is an integrated circuit switch. In accordance with one embodiment of the present invention, the device further includes a signal amplification unit coupled to the main signal path.

In accordance with one embodiment of the present invention, the plurality of signal filters includes an array of band pass filters arranged parallel to one another in the array, which is arranged in series with the main signal path, each of the band pass filters in the array having a respective switching means. Preferably, the selection of a particular band pass filter by closing the respective switching means results in a passage of a frequency range associated with the particular band pass filter. Preferably, the controller is configured to select each band pass filter by the respective switching means. Preferably, the switching means is an integrated circuit switch. In accordance with one embodiment of the present invention, the device further includes a signal amplification unit coupled to the main signal path.

In accordance with one embodiment of the present invention, the plurality of signal filters includes a plurality of band stop filters connected in series between a ground and the main signal path, and a bypass path including a respective switching means associated with each of the band stop filters. Preferably, the selection of a particular band stop filter by opening the respective switching means results in a passage through the main signal path of a frequency range associated with the particular band stop filter. Preferably, the controller is configured to select each band stop filter by the respective switching means. In accordance with one embodiment of the present invention, the controller is manually actuated using an interface mounted on the device. In accordance with one embodiment of the present invention, the controller is an analog circuit controllable using an informational signal received through the signal transmission line. In accordance with one embodiment of the present invention, the controller is a microprocessor controllable using an informational signal received through the signal transmission line.

In accordance with one embodiment of the present invention, a method is provided for conditioning an upstream bandwidth transmitted through a transmission line of a CATV system using a device located on a premise of a user. The method includes providing a main signal path, and providing a filter array comprising a plurality of discrete signal filters coupled to the main signal path. Each of the signal filters is configured to reduce a signal level of at least one frequency portion of an upstream bandwidth. The method further includes selectively engaging at least one of the signal filters such that a signal level of a lower frequency portion of the upstream bandwidth and a signal level of an higher frequency portion of the upstream bandwidth are reduced by a greater amount than a signal level of an intermediate frequency portion, which includes frequencies arranged between the lower frequency portion and the higher frequency portion. In accordance with one embodiment of the present invention, the method further includes amplifying at least the intermediate frequency portion of the upstream bandwidth.

In accordance with one embodiment of the present invention, the plurality of signal filters includes an array of low-pass filters and an array of high-pass filters. Preferably, the step of selectively engaging includes selecting at least one low-pass filter from the array of low-pass filters, and selecting at least one high-pass filter from the array of high-pass filters. The high-pass filter array and the low-pass filter array are coupled in series with the main signal path via switching means.

In accordance with one embodiment of the present invention, the method further includes selectively engaging an additional one of the signal filters such that a signal level of a frequency portion within the intermediate frequency portion is reduced by a greater amount than remaining portions of the intermediate frequency portion.

In accordance with one embodiment of the present invention, the plurality of signal filters includes a plurality of band pass filters. Each band pass filter is arranged between a ground and the main signal path and is selectively coupled to the main signal path by a respective switching means. The step of selectively engaging includes selecting at least one of the band pass filters by closing the respective switching means to attenuate a frequency range associated with the particular band pass filter.

In accordance with one embodiment of the present invention, the plurality of signal filters includes a plurality of band stop filters arranged in series with the main signal path and a bypass path including a respective switching means associated with each of the band stop filters. The step of selectively engaging includes selecting at least one of the band stop filters by opening the respective switching means to attenuate a frequency range associated with the particular band stop filter.

In accordance with one embodiment of the present invention, the plurality of signal filters includes an array of band pass filters arranged parallel to one another in the array, which is arranged in series with the main signal path. Each of the band pass filters in the array has a respective switching means. The step of selectively engaging includes selecting a particular band pass filter by closing the respective switching means to pass a frequency range associated with the particular band pass filter.

In accordance with one embodiment of the present invention, the plurality of signal filters includes a plurality of band stop filters connected in series between a ground and the main signal path and a bypass path including a respective switching means associated with each of the band stop filters. The step of selectively engaging includes opening the respective switching to pass a frequency range associated with the particular band stop filter through the main signal path.

### BRIEF DESCRIPTION OF THE DRAWINGS

For a further understanding of the objects of the invention, reference will be made to the following detailed description of the invention which is to be read in connection with the accompanying drawings, where:

FIG. 1 is a graphical representation of a CATV system arranged in accordance with an embodiment of the present invention;

FIG. 2 is a graphical representation of a premise of a user arranged in accordance with an embodiment of the present invention;

FIG. 3 is a circuit diagram of an upstream bandwidth conditioning device made in accordance with an embodiment of the present invention;

FIG. 4 is a graphical representation of a filter array made in accordance with one embodiment of the present invention;

FIG. 5 is a circuit diagram of the filter array represented in FIG. 4;

FIG. 6 is a graphical representation of another embodiment of a filter array made in accordance with one embodiment of the present invention;

FIG. 7 is a graphical representation of another embodiment of a filter array made in accordance with one embodiment of the present invention;

FIG. 8 is a graphical representation of another embodiment of a filter array made in accordance with one embodiment of the present invention; and

FIG. 9 is a graphical representation of another embodiment of a filter array made in accordance with one embodiment of the present invention.

The drawings are not necessarily to scale, emphasis instead generally being placed upon illustrating the principles of the invention. In the drawings, like numerals are used to indicate like parts throughout the various views.

### DETAILED DESCRIPTION OF THE INVENTION

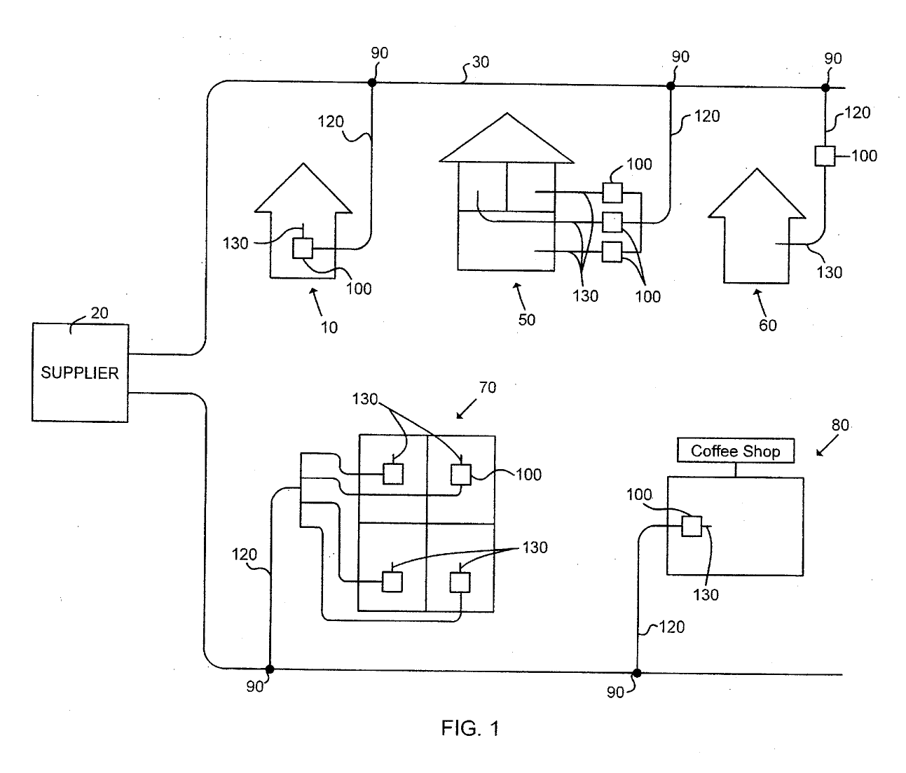

As shown in FIG. 1, a CATV system typically includes a supplier 20 that transmits a downstream bandwidth, such as RF signals, digital signals, and/or optical signals, to a user through a main distribution system 30 and receives an upstream bandwidth, such as RF signals, digital signals, and/or optical signals, from a user through the same main signal distribution system 30. A tap 90 is located at the main signal distribution system 30 to allow for the passage of the downstream/upstream bandwidth from/to the main signal distribution system 30. A drop transmission line 120 is then used to connect the tap 90 to a house 10, 60 an apartment building 50, 70, a coffee shop 80, and so on. As shown in FIG. 1, an upstream bandwidth conditioning device 100 of the present invention may be connected in series between the drop transmission line 120 and a user's premise distribution system 130.

Referring still to FIG. 1, it should be understood that the upstream bandwidth conditioning device 100 can be placed at any location between the tap 90 and the user's premise distribution system 130. This location can be conveniently located within a premise (e.g., the house 10, the apartment building 50, etc.), or proximate to the premise (e.g., the house 60, the apartment building 70, etc.). It should be understood that the upstream bandwidth conditioning device 100 can be placed at any location, such as the coffee shop 80 or other business, where CATV services, including internet services, VOIP services, or other unidirectional/bidirectional services are being used.

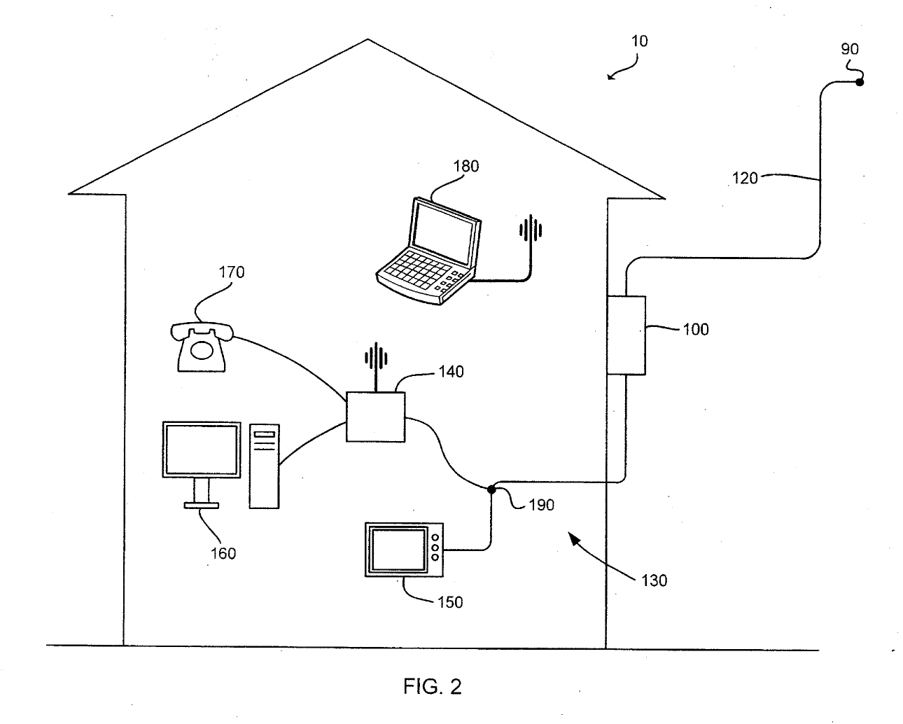

As shown in FIG. 2, the user's premise distribution system 130 may be split using a splitter 190 so that downstream/upstream bandwidth can pass to/from a television 150 and a modem 140 in accordance with practices well known in the art. The modem 140 may include VOIP capabilities affording telephone 170 services and may include a router affording internet services to a desktop computer 160 and a laptop computer 180, for example.

Additionally, it is common practice to provide a set-top box (“STB”) or a set-top unit (“STU”) for use directly with the television 150. For the sake of clarity, however, there is no representation of a STB or a STU included in FIG. 2. The STB and STU are mentioned here in light of the fact that many models utilize the upstream bandwidth to transmit information relating to “pay-per-view” purchases, billing, utilization, and other user interactions, all of which may require information to be sent from the STB or STU to the supplier 20. Accordingly, it should be understood that even though FIG. 2 explicitly shows that there is only one upstream bandwidth conditioning device 100 used for one device (i.e., the modem 140), each upstream bandwidth conditioning device 100 may be used with two or more devices (e.g., a modem, a STB, a STU, and/or a dedicated VOIP server) that transmit desirable upstream information signals via the upstream bandwidth.

Further, while not shown explicitly in FIG. 2, there may be two (or more) upstream bandwidth conditioning devices 100 located within or proximate to a single premise. For example, there may be an upstream bandwidth conditioning device 100 located between the modem 140 and the splitter 190 and another upstream bandwidth conditioning device 100 located between an STB or STU on the television 150 and the splitter 190. Similarly, there may be an upstream bandwidth conditioning device 100 located at any point in the premise distribution system 130 where an upstream bandwidth is being passed (e.g., from a modem, a STB, a STU, a VOIP server, etc.).

Further, while not shown explicitly in FIG. 2, there may by one upstream bandwidth conditioning device 100 located proximate to two user premises when there is one drop transmission line 120 used to connect the tap 90 to both of the two user premises. Even though such an arrangement is not considered ideal, because the upstream bandwidth from two users may be merged prior to being conditioned, such an arrangement may be necessary when the two premises are located too closely to one another for the physical placement of separate upstream bandwidth conditioning devices 100.

It should be understood that the goal of placing the upstream signal conditioning device 100 into one of the locations described above is to increase the overall quality of the upstream bandwidth in the main distribution system 30 by increasing the signal-to-noise ratio of the upstream bandwidth leaving a user's premise before that particular user's upstream bandwidth is merged with those of other users. As discussed above, merely amplifying the upstream bandwidth fails to achieve the desired result because the undesirable interference signals present in the upstream bandwidth are also amplified.

A significant amount of undesirable interference signals may occur within lower frequencies of the upstream bandwidth and within higher frequencies of the upstream bandwidth, while the desirable information signals are often present in intermediate frequencies of the upstream bandwidth. For example, in an upstream bandwidth spanning 5-42 MHz, there may be no desirable information signals in the 5-11 MHz range and in the 37-42 MHz range, while there are likely desirable information signals in the 11-37 MHz range. Based on this example, the signal-to-noise ratio of this upstream bandwidth could be significantly increased by attenuating or blocking signals in the 5-11 MHz range and the 37-42 MHz range while amplifying signals the 11-37 MHz range. While a system with a fixed range of attenuation and a fixed range of amplification may be helpful to increase the signal-to-noise ratio in the upstream bandwidth in the present example, it is expected that (i) additional undesirable interference signals may remain present in the amplified range, (ii) desirable information signals may not always be present in the amplified range, (iii) desired signals may become present in the attenuated range, and (iv) and the entire range of the upstream bandwidth may change. Accordingly, the present upstream bandwidth conditioning device 100 has been developed to change the range of frequencies attenuated at a lower frequency portion and a higher frequency portion such that the intermediate frequency portion can be broadened and/or narrowed as necessary to allow the passage of the desirable information signals. Further, in accordance with some embodiments of the present invention, particular portions of the intermediate frequency portion may also be attenuated.

Further, a secondary benefit of some embodiments of the upstream bandwidth conditioning device 100 is that the intermediate frequency portion can be broadened as required to accommodate any future changes to the CATV system that increase the size of the upstream bandwidth from the current range of 5-42 MHz to 5-85 MHz, for example, to allow for a greater flow of upstream information signals. While this is not the primary purpose of the present upstream signal conditioning device 100, the ability for the device 100 to accommodate such changes allows the device 100 to remain relevant after such changes. Any devices that can not accommodate a change to a broader upstream bandwidth will inherently block the expanded portion of the upstream bandwidth, and will, therefore need to be replaced or physically altered once the upstream bandwidth is broadened.

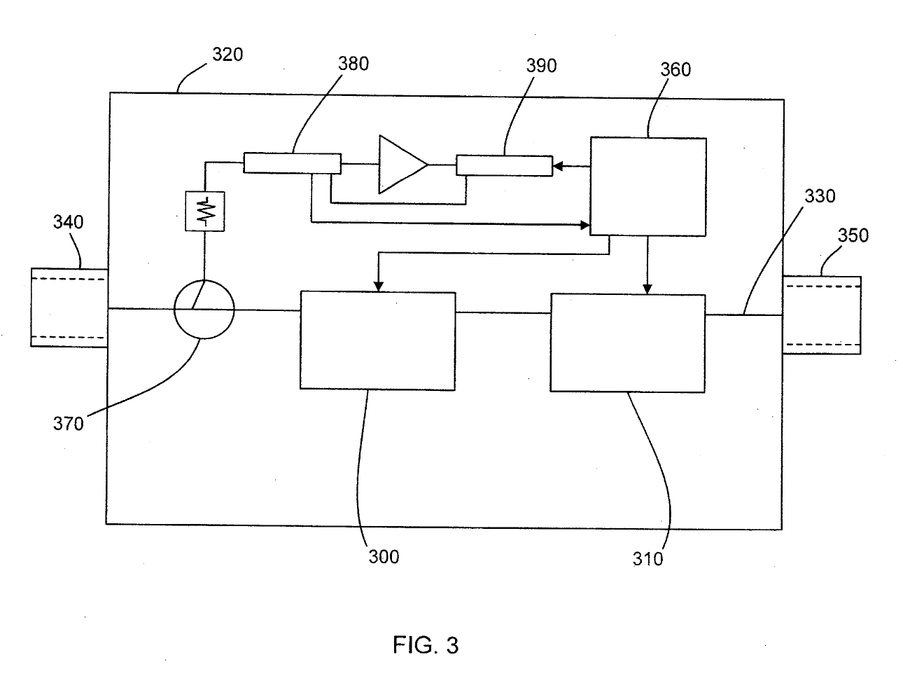

Referring now to FIG. 3, one embodiment of the upstream bandwidth conditioning device 100 includes a filter array 300 and a signal amplification device 310 mounted in a housing 320. The filter array 300 and the signal amplification device 310 are coupled to an user-side connector 340 and a supplier-side connector 350 using a main signal path 330. The upstream bandwidth conditioning device 100 can be arranged, as shown, such that the upstream bandwidth passes through the filter array 300 prior to entering the signal amplification device 310. In this arrangement, the undesirable interference signals in the lower frequency portion, the higher frequency portion, and any other frequency portions of the upstream bandwidth, are removed prior to amplification. Alternatively, the upstream bandwidth conditioning device 100 could be arranged such that the upstream bandwidth passes through the filter array 300 after passing through the signal amplification device 310. The latter arrangement could attenuate any undesirable interference signals created by the signal amplification device 310.

The signal amplification device 310 can be any of the well known devices for amplifying a signal, whether it is an electromagnetic signal or an optical signal. For example, a conventional bipolar transistor amplifier or a field-effect transistor amplifier could be used to amplify electromagnetic signals. A few of the possible variations of the filter array 300 will be discussed more fully below.

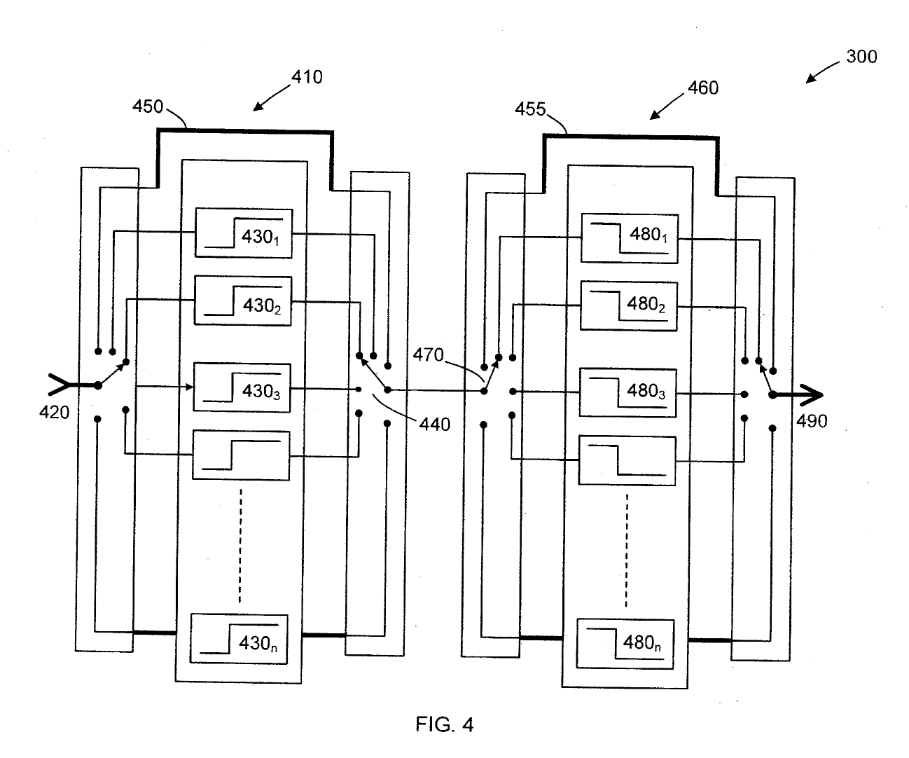

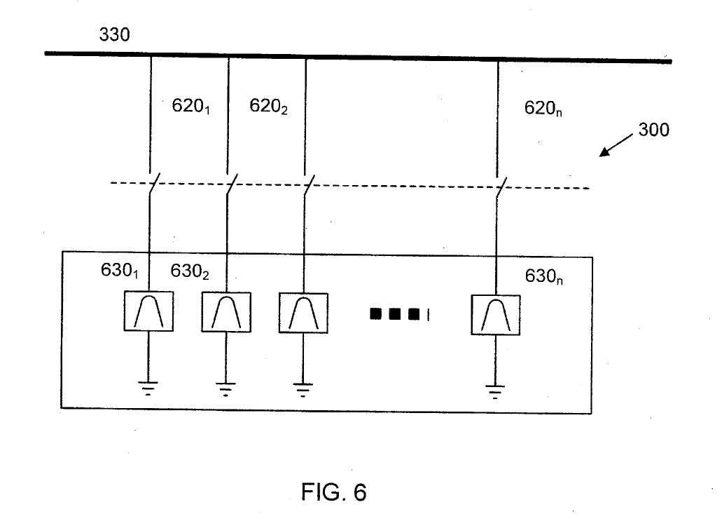

A pair of diplexer filters (not shown) may be utilized with one diplexer positioned between the filter array 300 and the user-side connector 340 and the other positioned between the filter array 300 and the supplier-side connector 350. The purpose of the diplexer filters would be to create a return path separate from a forward path, with the return path carrying the upstream bandwidth and the forward path carrying the downstream bandwidth. In such an embodiment, the filter array 300 and the signal amplification device 310 (if used) may be located on the return path. Such an arrangement allows the downstream bandwidth to pass unimpeded and unaltered by the filter array 300 and the signal amplification device 310 (if used) located in the return path. It should be understood, however, that the use of the diplexer filters is not required unless it is determined that the particular filter array 300 and/or the amplification device 310 would adversely alter the downstream bandwidth. For example, some embodiments of the filter array 300, such as the embodiment represented in FIG. 4 (discussed below), may attenuate the frequencies of the downstream bandwidth such that the diplexer filters may be required. Other embodiments of the filter array 300, such as the one represented in FIG. 6 (discussed below), may not require the use of the diplexer filters. It should be understood that even though the embodiment shown in FIG. 6 may not require the use of the diplexer filters, diplexer filters may be present. In any of the embodiments, the use of a single pair of diplexers, each having fixed cut-off frequencies, may result in a upstream bandwidth conditioning device 100 that may not be able to accommodate a change to the CATV system that increases the size of the upstream bandwidth without replacing the pair of diplexers.

Still referring to FIG. 3, each of the user-side connector 340 and the supplier-side connector 350 can be a traditional threaded 75 ohm connector so that the upstream bandwidth conditioning device 100 can be easily placed in series with any portion of the premise distribution system 130 and/or in series between the drop transmission line 120 and the premise distribution system 130 using readily available “F” type connectors. This “in series” placement ensures that all of the all of the downstream/upstream signals pass through the upstream bandwidth conditioning device 100. It should be understood that each of the user-side connector 340 and the supplier-side connector 350 may be a connector other than an “F” type connector. For example, at least one of the connectors 340, 350 may be a proprietary connector (i.e. a non-industry standard connector) designed to hinder attempts at tampering with or to hinder attempts at stealing of the upstream bandwidth conditioning device 100. Other connector types may also be used depending on the type and/or size of the drop transmission line 120, the type and/or size of the premise distribution system 130, or the impedance of the system. With regard to the latter, it should be understood that connectors are purposefully varied in some instances to avoid the placement of components having one characteristic impedance (e.g., 75 Ohms) in a system having another characteristic impedance (e.g., 50 Ohms).

For the continuing description of FIG. 3, it must be understood that each embodiment of filter array 300 will have some form of switching means and may potentially include the signal amplification device 310. This aspect is important at this point in the discussion because the switching means, regardless of the embodiments discussed below, and potentially the signal amplification device 310 are controlled by a controller 360, which actuates the switching means in response to: (i) a physical input; (ii) an information transmission signal sent by the supplier 20, and/or (iii) a device located within the premise of the user. In other words, the controller 360 then provides an external input to each of the switching means, the external input dictating which position the switching means should take. This external input provided to the switching means by the controller 360 may be an on/off voltage in the case of a traditional, commonly available single-pole, single-throw (SPST) analog switching. The external input provided by the controller 360 may also be a serially arranged digital signal in the case of traditional, commonly available SPST switch controlled via a 3 wire serial interface. It should be understood that the external input may take other forms as would be understood by one skilled in the part based on the present disclosure. The controller may also provide a pulse width modulated (PWM) signal, a common method of controlling an amplification device, to the amplification device 310 to indicate the amount of amplification desired.

In the embodiment shown in FIG. 3, a signal coupler 370 allows for a receiver 380 to receive the information transmission signal. The signal coupler 370 is shown in the main signal path 330 between the user-side connector 340 and the filter array 300. The signal coupler is placed in this location to receive portions of the downstream bandwidth from the supplier. The signal coupler 370 may also be located near the supplier-side connector 350. The signal coupler 370 may be located in the latter position in the case where an information transmission signal from a device in the premise of the user may be attenuated by the filter array 300 before reaching the 370. Similarly, there may be a signal coupler located in each of the two locations. In either case, the signal coupler may be placed somewhere along the main signal path, outside of the pair of diplexers discussed above, when information transmission signals are expected in the upstream bandwidth as well as the downstream bandwidth. This aspect should become more clear based on the discussion regarding the information transmission signal below.

The frequency of the receiver 380 can be set by the controller 360 and can be tuned to a particular frequency by a phase-locked loop control system 390 in any of the manners that are well known in the art. The receiver 380 may also be fixed to a single frequency if and/or when that frequency is sufficient to carry the desired information transmission signal. It should be understood that the particular frequency is only important to the degree that the receiver 380 must be tuned to a particular frequency where the information transmission signal is expected in order to receive the information transmission signal. In the present instance, the particular frequency is a frequency within a range of 110-135 MHz because the components of the receiver 380, a low power mixer FM IF system SA605DK and clock generator ADF4001, are relatively inexpensive for this frequency range. It should also be understood that the particular frequencies may, as in the present case, be a frequency within a typical CATV channel, but between the video carrier frequency and audio carrier frequency.

Further, as described below, there may be multiple particular frequencies with some located in the upstream bandwidth and some located in the downstream bandwidth. For example, when the information transmission signal is being passed from the supplier 20, the information transmission signal may be sent on one or more particular frequencies within the downstream bandwidth. Alternatively, when the information transmission signal is sent from a device within the premise of the user, the information transmission signal may be sent using one or more particular frequencies within the upstream bandwidth. In such cases, there may be one receiver 380 that is tunable between the particular frequencies or one receiver 380 for each particular frequency (e.g., one receiver for use with the upstream bandwidth, and one receiver for use with the downstream bandwidth).

In its simplest form, the information transmission signal can be a tone, such as a 100 kHz tone that is RF modulated onto the particular frequency. Is a tone is going to be used as an information transmission signal, the receiver 380 may then include a tone demodulator, which are well known in the art, to identify whether a tone is present and provide an output to the controller 360 indicating whether a tone is present. As indicated above, there may be provisions in the upstream bandwidth conditioning device 100 for more than one receiver 380 or a receiver 380 that can tune to a plurality of frequencies to identify tones in those frequencies for the purpose of providing a more detailed control of the upstream bandwidth conditioning device 100. The more detailed control may allow for more precise control of the frequencies that are to be attenuated and that are to be passed and amplified. This more detailed control may also be accomplished by incorporating an information transmission signal that includes a coded operational signal.

A coded operational signal may be provided on the particular frequency along with the tone, or the coded operational signal may be provided by itself on the particular frequency. In the present embodiment, a coded operational signal is RF modulated along with the tone. For example, the coded operational signal is provided at 500 MHz on the particular frequency, and provides for a transfer rate of 2400 baud. To accommodate the tone and the coded operational signal in the present example, the mixer in the receiver 380 provides two outputs, one with a band pass filter to pass the 100 Hz tone to the tone demodulator, and one with a band pass filter to pass the 500 MHz signals to a demodulator, which is well known in the art, to convert the RF signals into a data steam, such as RS232, suitable for use by the controller 360.

It is also envisaged that the receiver 380 of the upstream bandwidth conditioning device 100 may include full cable modem functionality. For example, the controller 360 may include a cable modem configured to operate in accordance with the DOCSIS standard such that the supplier 20 would be able to access each individual upstream bandwidth by an identifiable address, such as a modem number and/or a TCP/IP address. Using this format, the supplier can provide the controller 380 with a detailed set of parameters, including the frequencies to be attenuated, the frequencies to be pass, and how much amplification to apply to the frequencies that are passed, using information transfer and control methods that will be understood by one skilled in the art based on the present specification.

It should be understood that any of the known information transmission signals, including those described above, may be incorporated into the present upstream bandwidth conditioning device 100. It is also important to note that the present upstream bandwidth conditioning device 100 may be configured to accept a combination of the known information transmission, such as tones, digital signals to be demodulated into serial data, digital signals according to the DOCSIS standard, and any other information signals that perform a similar function to these.

The functionality of the controller 360 and how it utilizes the information transmission signals will become clearer with the discussion of each embodiment of the present invention below. Along these lines, it is important to remember that the controller 360 may actuate the switching means of each embodiment and the signal amplification device 310 (if installed) based on the information control signals provided in the downstream bandwidth by the supplier 20 and/or the upstream bandwidth by a device in the premise of the user.

In light of the forgoing, it should also be understood that the controller 360 can be any one of a variety of devices depending on the sophistication of the information transmission signals to be used. In the most simplistic case, the controller 360 can be a manual input device allowing a service technician to manually enter the frequencies that are to be attenuated, passed, amplified, or otherwise conditioned. As it is shown in FIG. 3 with the receiver 380 and the phase-locked loop control system 390, the controller 360 may preferably be an analog logic circuit or a microprocessor. In an example using tones for the information transmission signals, an analog circuit may be suitable to control the the switching means and potentially the signal amplification device 310 based on whether the tone is present. However, it may be more simple to utilize a microprocessor, which can be easily programmed incorporate the information provided in the information transmission signal and actuate the switching means and potentially the signal amplification device 310 based on the provided information.

Referring now to FIG. 4, one embodiment of the filter array 300 includes a high-pass filter array 410 and a low-pass filter array 460 arranged in series. The high-pass filter array 410 includes a number of high-pass filters 430₁-430ₙ and an optional bypass element 450 (i.e., a cable, a path or a trace that does not include a filter). The cut-off frequencies of the high-pass filters 430₁-430ₙ can compose an arithmetic sequence with a common difference equal to a pre-defined value such as 2 MHz. For example, the high-pass filter 430₁ attenuates signals 2 MHz and below, the high-pass filter 430₂ attenuates signals 4 MHz and below, the high-pass filter 430₃ attenuates signals 6 MHz and below, and so on. To access each of the high-pass filters 430₁-430ₙ, the high-pass filter array 410 includes switching means 420 and 440. Each of the switching means 420, 440 can be configured to select the bypass element 450 should the need arise. In the present embodiment, each of the switching means 420,440 can be one or more CMOS SPST multichannel switches controlled by the controller 360 using a serial interface. It should be understood that such multichannel switched may be replaced with a plurality of signal channel switches without a functional loss to the device.

Each of the switching means 420 and 440 includes one or more switches that allows signals to flow to one of the high-pass filters 430₁-430ₙ and the bypass element 450 (if installed) while not allowing signals to flow to the remaining of the high-pass filters 430₁-430ₙ and the bypass element 450 (if installed). An open position may also be desired to offer a position where no signals are passed to any of the high-pass filters 430₁-430ₙ and the bypass element 450 (if installed). In the case shown in FIG. 3, each of the switching means 420, 440 are shown as being able to switch between a plurality of positions, also known as channels. The number of channels may be at least the number of high-pass filters 430₁-430ₙ plus one position for the bypass element 450 (if installed) and an open position (if desired). If the number of channels required by the number of filters 430₁-430ₙ, the bypass element 450 (if installed), and the open position (if desired) exceeds the number of channels provided in a single multichannel SPST switch, such as a CMOS SPST switch, more than one of these switches may be used. While not shown explicitly, the multichannel SPST switch may controlled by the controller 360 using a serial interface. It should be understood that such multichannel switches may be replaced with a plurality of signal channel switches without a functional loss to the device. Further, it should be understood that such multichannel switches may be replaced with a mechanical switch that can actuate to select between a plurality of channels as opposed to the SPST switch that has a single switch per channel. Many other switches may be suitable as will be understood by one skilled in the art based on the present specification.

Still referring to FIG. 4, the low-pass filter array 460 of the filter array 300 includes a number of low-pass filters 480₁-480ₙ and an optional bypass element 455. Similar to the high-pass filter array 410, the cut-off frequencies of the low-pass filters 480₁-480ₙ can compose an arithmetic sequence with the common difference equal to a pre-defined value such as 2 MHz. For example, the low-pass filter 480₁ attenuates signals 26 MHz and above, the low-pass filter 480₂ attenuates signal 28 MHz and above, the high-pass filter 480₃ attenuates 30 MHz and above, and so on. To access each of the low-pass filters 480₁-480ₙ, the low-pass filter array 460 includes switching means 470, 490. The switching means 470 and 490 can be configured to select the bypass element 455 should the need arise.

Similar to as discussed above, each of the switching means 470 and 490 includes one or more switches that allows signals to flow to one of the low-pass filters 480₁-480ₙ and the bypass element 455 (if installed) while not allowing signals to flow to the remaining of the low-pass filters 480₁-480ₙ and the bypass element 455 (if installed). An open position may also be desired to offer a position where no signals are passed to any of the low-pass filters 480₁-480ₙ and the bypass element 455 (if installed). As discussed above, each of the switching means 470 and 490 may be one or more multichannel SPST switches, a plurality of single channel SPST switches, a mechanical switch capable of selecting between a plurality of channels or many of the other know switches.

In light of the forgoing, the filter array 300 in the embodiment represented in FIG. 4 provides a band pass allowing for an intermediate frequency portion to pass without significant attenuation. The size and location of this intermediate frequency portion is defined by the specific combination of the high-pass filters 430₁-430ₙ and the low-pass filters 480₁-480ₙ selected. Using the examples from above, if the high-pass filter 430₃ is selected and the low-pass filter 480₂ is selected, the intermediate frequency portion would be 6-28 MHz. If the bypass elements 450 and 455 are selected by both the switching means 420 and 440 and the switching means 470 and 490 respectively, then the filter array 300 functions as an all pass filter (bypass). If the open position (not shown) is selected by any of the switching means 420, 440, 470, or 490, then the filter array can provide an all stop filter (open circuit).

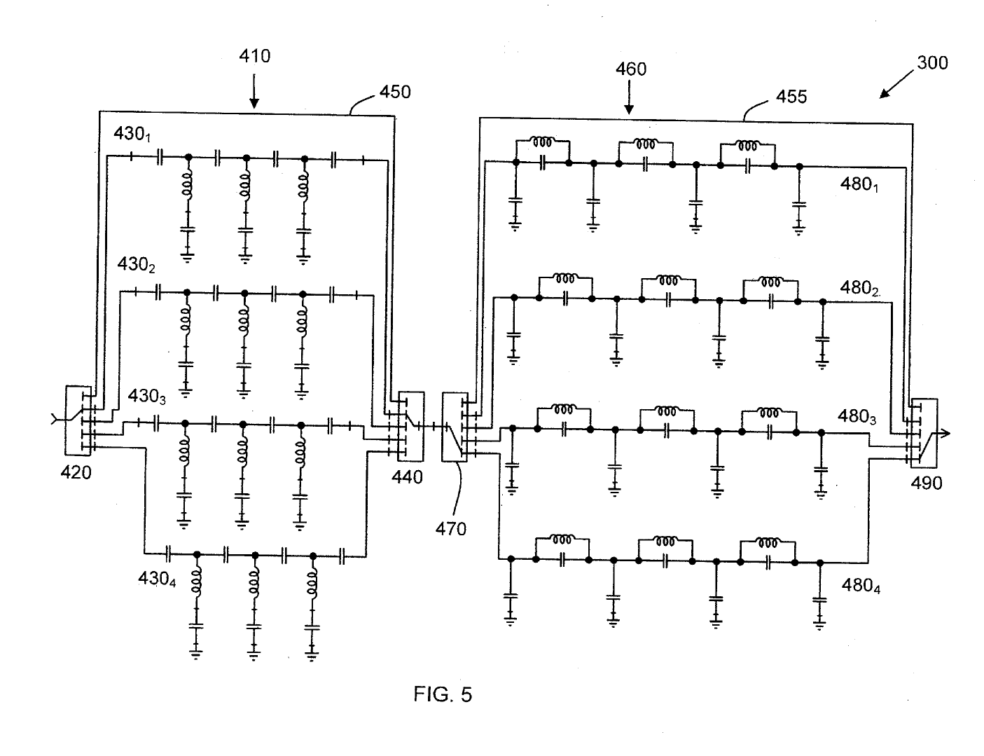

Referring to FIG. 5, each of the high pass filter array 410 and the low-pass filter array 460 of the filter array 300 includes a number of resonant (RLC) circuits, each including one or more resistors (R), one or more inductors (L), and one or more capacitors (C), connected in series or in parallel. Each of the resistors, inductors, and capacitors are represented in FIG. 5 by their industry standard symbols. The remaining reference numbers are equivalent to those discussed above in relation to FIG. 4.

Referring now to FIG. 6, another embodiment of the filter array 300 includes a number of band pass filters 630₁-630ₙ, which are selectable by respective switching means 620₁-620ₙ. One or more the band pass filters 630₁-630ₙ, if selected by the respective switching means 620₁-620ₙ, will shunt to ground signals of the respective one or more frequency bands being transmitted over the main signal path 330, thus providing a multi-band band stop filter.

In use, the present embodiment can take a variety of forms. For example, creating an attenuation of the frequencies up to 6 MHz and above 28 MHz can be accomplished in at least two ways utilizing the basic structure shown in FIG. 6. In the first scenario, each of the band pass filters 630₁-630₂₆ are part of a series incrementing by, for example, 2 MHz (assuming that there are 26 filters/switches). Accordingly, band pass filter 630₁ attenuates 0-2 MHz, band pass filter 630₂ attenuates 2-4 MHz, band pass filter 630₃ attenuates 4-6 MHz, (sequence continuing), band pass filter 630₂₅ attenuates 48-50 MHz, and band pass filter 630₂₆ attenuates 50-52 MHz. Accordingly, to allow for an intermediate frequency range of 6-28 MHz to pass, switches 620₁-620₃ and 620₁₅-620₂₆ would need to be actuated to engage band pass filters 630₁-630₃ and 630₁₅-630₂₆.

In this scenario, individual intermediate frequency portions may be attenuated separate from the higher frequency portion and the lower frequency portion. For example, within the intermediate frequency range of 6-28 MHz passed in the example above, additional frequency portions, such as 14-18 MHz can be attenuated by actuating switches 620₇-620₉. Along these lines, even further frequency portions within the intermediate frequency range of 6-28 MHz can be attenuated.

According to a second scenario, each of the filters 630₁-630₁₃ becomes incrementally broader by 2 MHz up to a frequency attenuation range of 0-26 MHz, and each of the filters 630₁₄-630₂₆ decreases by 2 MHz from a range of 26-52 MHZ (630₁₄) to 50-52 MHz (630₂₆). Accordingly, to allow for an intermediate frequency range 6-28 MHz to pass, switches 620₃ and 620₁₄ would need to be actuated to engage band pass filters 630₃ and 630₁₄.

Please note that for the preceding examples and for those that follow, the number of filters has been arbitrarily identified is 26 (i.e., XXX₁-XXX₂₆), and the increment has been arbitrarily identified as 2 MHz. It should be understood that the number of filters and the increment may be different. For example, due to cost or complexity, the number of filters may be reduced to 20, 10, or even 5. Similarly, the increment may be something more along the lines of 5, 10, or 20 MHz. The overall goal is to cover the entire possible width of the upstream bandwidth, which is likely to grow from a maximum of 42 MHz to 85 MHz, and potentially beyond.

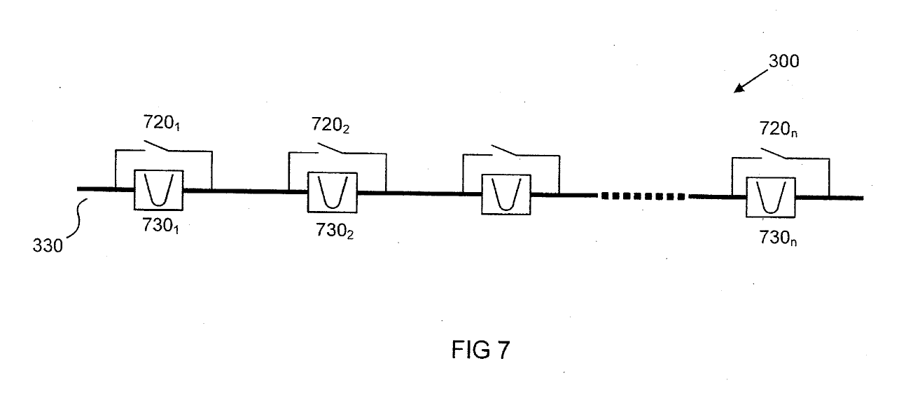

Referring now to FIG. 7, another embodiment of the filter array 300 includes a plurality of band stop filters 730₁-730ₙ, each of which is selectable by respective switching means 720₁-720ₙ and is connected in series with the main signal path 330. One or more of the filters 730₁-730ₙ, if selected by the respective switching means 720₁-720ₙ, can provide a multi-band band stop filter.

In use, the present embodiment can take a variety of forms. For example, creating an attenuation of the frequencies up to 6 MHz and above 28 MHz can be accomplished in at least two ways utilizing the basic structure shown in FIG. 7. In the first scenario, each of the band stop filters 730₁-730₂₆ are part of a series incrementing by, for example, 2 MHz (assuming that there are 26 filters/switches). Accordingly, band stop filter 730₁ attenuates 0-2 MHz, band stop filter 730₂ attenuates 2-4 MHz, band stop filter 730₃ attenuates 4-6 MHz, (sequence continuing), band stop filter 730₂₅ attenuates 48-50 MHz, and band stop filter 730₂₆ attenuates 50-52 MHz. Accordingly, to allow for an intermediate frequency range of 6-28 MHz to pass, switches 720₁-720₃ and 720₁₅-720₂₆ would need to be left open to engage band stop filters 730₁-730₃ and 730₁₅-730₂₆, and switches 720₄-720₁₄ would be closed to bypass filters 720₄-720₁₄.

In this scenario, individual intermediate frequency portions may be attenuated separate from the higher frequency portion and the lower frequency portion. For example, within the intermediate frequency range of 6-28 MHz passed in the example above, additional frequency portions, such as 14-18 MHz can be attenuated by opening switches 720₇-720₉. Along these lines, even further frequency portions within the intermediate frequency range of 6-28 MHz can be attenuated.

According to a second scenario, each of the band stop filters 730₁-730₁₃ becomes incrementally broader by 2 MHz up to a frequency attenuation range of 0-26 MHz, and each of the band stop filters 730₁₄-730₂₆ decrease by 2 MHz from a range of 26-52 MHZ (730₁₄) to 50-52 MHz (730₂₆). Accordingly, to allow for an intermediate frequency range 6-28 MHz to pass, switches 720₃ and 720₁₄ would need to be open to engage band stop filters 730₃ and 730₁₄, and the remaining switches would remain closed to bypass the remaining band stop filters.

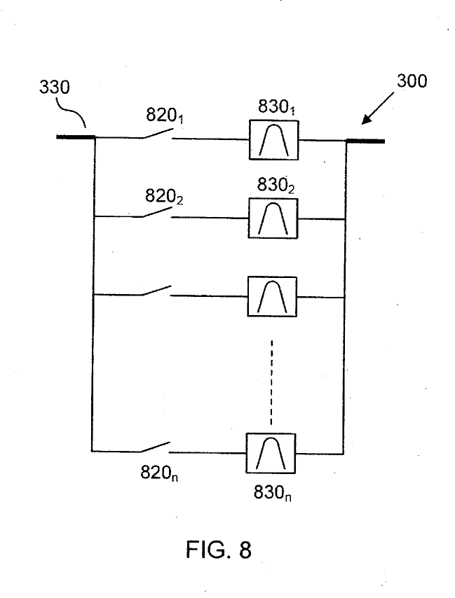

With reference to FIG. 8, another embodiment of the filter array 300 includes a plurality of band pass filters 830₁-830ₙ, each of which is connected in parallel and is selectable by a respective switching means 820₁-820ₙ. The filter array 300 of the present embodiment is connected in series with the main signal path 330, and can provide a multi-band band pass filter.

In use, the present embodiment can take a variety of forms. For example, creating an attenuation of the frequencies up to 6 MHz and above 28 MHz can be accomplished by configuring each of the band pass filters 830₁-830₂₆ to be part of a series incrementing by, for example, 2 MHz (assuming that there are 26 filters/switches). Accordingly, band pass filter 830₁ passes 0-2 MHz, band pass filter 830₂ passes 2-4 MHz, band pass filter 830₃ passes 4-6 MHz, (sequence continuing), band pass filter 830₂₅ passes 48-50 MHz, and band pass filter 830₂₆ passes 50-52 MHz. Accordingly, to allow for an intermediate frequency range of 6-28 MHz to pass, switches 820₄-820₁₄ would need to be closed to engage band pass filters 830₄-830₁₄, and the remaining switches 820₁-820₃ and 820₁₅-820₂₆ would need to remain open.

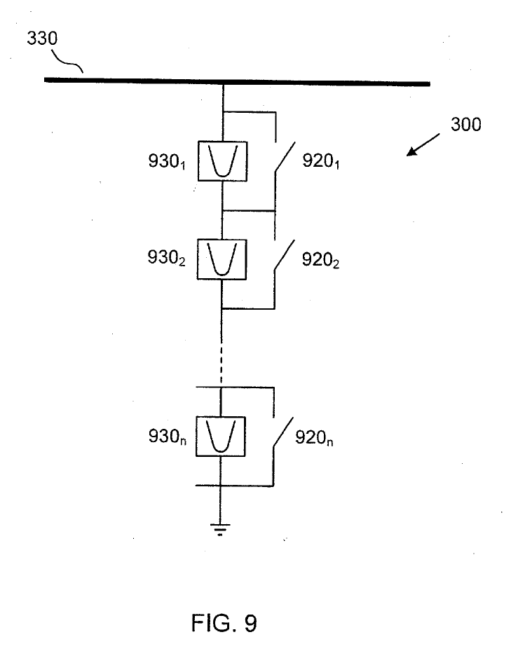

Referring now to FIG. 9, another embodiment of the filter array 300 includes a plurality of band stop filters 930₁-930ₙ, which are connected in series and are selectable by the respective parallel switching means 920₁-920ₙ. Selecting any of the band stop filters 930₁-930ₙ entails opening the respective one of the switching means 920₁-920ₙ. For example, to select the band stop filter 930₂, switch 920₂ is opened. By selecting a particular band stop filter, the range frequencies attenuated by that particular band stop filter is not shunted to ground and is, therefore, not attenuating that range of frequencies in the main signal path 330. Accordingly, by selecting one or more of the band stop filters by opening their respective switches, the attenuation frequencies of those selected band stop filters are the frequencies that are not attenuated in the main signal path 330.

In use, the present embodiment can take a variety of forms. For example, creating an attenuation of the frequencies up to 6 MHz and above 28 MHz can be accomplished in at least two ways utilizing the basic structure shown in FIG. 9. In the first scenario, each of the band stop filters 930₁-930₂₆ are part of a series incrementing by, for example, 2 MHz (assuming that there are 26 filters/switches). Accordingly, selecting band stop filter 930₁ allows 0-2 MHz to pass through the main signal path 330, selecting band stop filter 930₂ allows 2-4 MHz to pass through the main signal path 330, selecting band stop filter 930₃ allows 4-6 MHz to pass through the main signal path 330, (sequence continuing), selecting band stop filter 930₂₅ attenuates 48-50 MHz to pass through the main signal path 330, and selecting band stop filter 930₂₆ attenuates 50-52 MHz to pass through the main signal path 330. Accordingly, to allow for an intermediate frequency range of 6-28 MHz to pass, switches 920₁-920₃ and 920₁₅-920₂₆ would need to be closed, and switches 920₄-920₁₄ would need to be open.

In this scenario, individual intermediate frequency portions may be attenuated separate from the higher frequency portion and the lower frequency portion. For example, within the intermediate frequency range of 6-28 MHz passed in the example above, additional frequency portions, such as 14-18 MHz can be attenuated by opening switches 920₇-920₉. Along these lines, even further frequency portions within the intermediate frequency range of 6-28 MHz can be attenuated.

According to a second scenario, assuming that there are 26 filters/switches, each of the filters 930₁-930₁₃ becomes incrementally narrower by 2 MHz, and each of the filters 930₁₄-930₂₆ becomes incrementally narrower by 2 MHz. For example, selecting band stop filter 930₁ allows 24-26 MHz to pass through the main signal path 330, selecting band stop filter 930₂ allows 22-26 MHz to pass through the main signal path 330, selecting band stop filter 930₃ allows 20-26 MHz to pass through the main signal path 330, (sequence continuing), selecting band stop filter 930₁₄ attenuates 26-28 MHz to pass through the main signal path 330, selecting band stop filter 930₁₅ attenuates 26-30 MHz to pass through the main signal path 330, and selecting band stop filter 930₁₆ attenuates 26-32 MHz to pass through the main signal path 330, and so on. Accordingly, to allow for an intermediate frequency range of 6-28 MHz to pass, switches 920₁₀ and 920₁₄ would need to be open.

A skilled artisan would appreciate the fact that other types of frequency filters and other implementations of filter assemblies are within the scope and the spirit of the present invention.

It should be understood that any of the filter array embodiments can be configured to allow for an attenuation of the entire upstream bandwidth should such an attenuation be required. For example, such attenuation can be useful for end users having CATV equipment which only uses the downstream transmission path.

While the present invention has been particularly shown and described with reference to the preferred mode as illustrated in the drawings, it will be understood by one skilled in the art that various changes in detail may be effected therein without departing from the spirit and scope of the invention as defined by the claims.

1. An upstream bandwidth conditioning device that can be inserted into a signal transmission line of a CATV system on or proximate to a premise of a user, said device comprising:
a main signal path;
a filter array comprising a plurality of discrete signal filters coupled to the main signal path, each of the signal filters being configured to reduce a signal level of at least one frequency portion of an upstream bandwidth; and
a controller configured to select between a plurality of filter operation states, in at least two of the filter operation states at least one of the signal filters is selected such that a signal level of a lower frequency portion of the upstream bandwidth and a signal level of a higher frequency portion of the upstream bandwidth are reduced by a greater amount than a signal level of an intermediate frequency portion, the intermediate frequency portion including frequencies arranged between the lower frequency portion and the higher frequency portion,
wherein the intermediate frequency portion is larger in one of the filter operation states than in another of the filter operation states.

2. The device of claim 1, wherein the plurality of discrete signal filters comprises an array of low-pass filters and an array of high-pass filters, and wherein in each of the at least two filter operation states at least one low-pass filter from the array of low-pass filters and at least one high-pass filter from the array of high-pass filters is selected by the controller based on at least one of a physical and an information transmission signal.

3. The device of claim 2, wherein the array of low-pass filters and the array of high-pass filters are coupled with the main signal path via switching means, the switching means being selectively actuated by the controller.

4. The device of claim 2, wherein each of the low-pass filters in the array attenuates to a different maximum frequency, and each of the high-pass filters in the array attenuates to a different minimum frequency.

5. The device of claim 3, wherein the switching means comprises at least two switches associated with each of the array of low-pass filters and the array of high-pass filters.

6. The device of claim 3, wherein the switching means is an integrated circuit switch.

7. The device of claim 4 further comprising a signal amplification unit coupled to the main signal path.

8. The device of claim 1, wherein the plurality of signal filters comprises a plurality of band pass filters, each band pass filter being arranged between a ground and the main signal path and being selectively coupled to the main signal path by a respective switching means.

9. The device of claim 8, wherein a selection of each band pass filter by closing the respective switching means results in an attenuation of a frequency range associated with the particular band pass filter.

10. The device of claim 9, wherein the controller is configured to select each band pass filters by the respective switching means.

11. The device of claim 9, wherein each of the plurality of band pass filters attenuates to a different maximum frequency and to a different minimum frequency.

12. The device of claim 9, wherein the switching means is an integrated circuit switch.

13. The device of claim 11 further comprising a signal amplification unit coupled to the main signal path.

14. The device of claim 1, wherein the plurality of signal filters comprises a plurality of band stop filters arranged in series with the main signal path and a bypass path including a respective switching means associated with each of the band stop filters.

15. The device of claim 14, wherein the selection of a particular band stop filter by opening the respective switching means results in an attenuation of a frequency range associated with the particular band stop filter.

16. The device of claim 15, wherein the controller is configured to select each band stop filter by the respective switching means.

17. The device of claim 12, wherein the switching means is an integrated circuit switch.

18. The device of claim 15 further comprising a signal amplification unit coupled to the main signal path.

19. The device of claim 1, wherein the plurality of signal filters comprises an array of band pass filters arranged parallel to one another in the array, which is arranged in series with the main signal path, each of the band pass filters in the array having a respective switching means.

20. The device of claim 19, wherein the selection of a particular band pass filter by closing the respective switching means results in a passage of a frequency range associated with the particular band pass filter.

21. The device of claim 20, wherein the controller is configured to select each band pass filter by the respective switching means.

22. The device of claim 19, wherein the switching means is an integrated circuit switch.

23. The device of claim 20 further comprising a signal amplification unit coupled to the main signal path.

24. The device of claim 1, wherein the plurality of signal filters comprises a plurality of band stop filters connected in series between a ground and the main signal path, and a bypass path including a respective switching means associated with each of the band stop filters.

25. The device of claim 24, wherein the selection of a particular band stop filter by opening the respective switching means results in a passage through the main signal path of a frequency range associated with the particular band stop filter.

26. The device of claim 25, wherein the controller is configured to select each band stop filter by the respective switching means.

27. The device of claim 1, wherein the controller is manually actuated using an interface mounted on the device.

28. The device of claim 1, wherein the controller is an analog circuit controllable using an informational signal received through the signal transmission line.

29. The device of claim 1, wherein the controller is a microprocessor controllable using an informational signal received through the signal transmission line.

30. A method of conditioning an upstream bandwidth transmitted through a transmission line of a CATV system using a device located on a premise of a user, the method comprising:
providing a main signal path;
providing a filter array comprising a plurality of discrete signal filters coupled to the main signal path, each of the signal filters being configured to reduce a signal level of at least one frequency portion of an upstream bandwidth;
selectively engaging at least one of the signal filters such that a signal level of a lower frequency portion of the upstream bandwidth and a signal level of an higher frequency portion of the upstream bandwidth are reduced by a greater amount than a signal level of an intermediate frequency portion, which includes frequencies arranged between the lower frequency portion and the higher frequency portion.

31. The method of claim 30 further comprising amplifying at least the intermediate frequency portion of the upstream bandwidth.

32. The method of claim 30, wherein the plurality of signal filters comprises an array of low-pass filters and an array of high-pass filters, and wherein the step of selectively engaging comprises:
selecting at least one low-pass filter from the array of low-pass filters; and
selecting at least one high-pass filter from the array of high-pass filters,
wherein the high-pass filter array and the low-pass filter array are coupled in series with the main signal path via switching means.

33. The method of claim 30 further comprising selectively engaging an additional one of the signal filters such that a signal level of a frequency portion within the intermediate frequency portion is reduced by a greater amount than remaining portions of the intermediate frequency portion.

34. The method of claim 30, wherein the plurality of signal filters comprises a plurality of band pass filters, each band pass filter arranged between a ground and the main signal path and being selectively coupled to the main signal path by a respective switching means, and wherein the step of selectively engaging comprises selecting at least one of the band pass filters by closing the respective switching means to attenuate a frequency range associated with the particular band pass filter.

35. The method of claim 30, wherein the plurality of signal filters comprises a plurality of band stop filters arranged in series with the main signal path and a bypass path including a respective switching means associated with each of the band stop filters, and wherein the step of selectively engaging comprises selecting at least one of the band stop filters by opening the respective switching means to attenuate a frequency range associated with the particular band stop filter.

36. The method of claim 30, wherein the plurality of signal filters comprises an array of band pass filters arranged parallel to one another in the array, which is arranged in series with the main signal path, each of the band pass filters in the array having a respective switching means, and wherein the step of selectively engaging comprises selecting a particular band pass filter by closing the respective switching means to pass a frequency range associated with the particular band pass filter.

37. The method of claim 30, wherein the plurality of signal filters comprises a plurality of band stop filters connected in series between a ground and the main signal path, and a bypass path including a respective switching means associated with each of the band stop filters, and wherein the step of selectively engaging comprises opening the respective switching to pass a frequency range associated with the particular band stop filter through the main signal path.
